(19) United States
(12) Patent Application Publication
(10) Pub. No.: US 2010/0141388 A1
(43) Pub. Date: Jun. 10, 2010

(54) SYSTEM FOR PROVIDING INFORMATION ON PIECES OF FURNITURE

(75) Inventor: Christopher Reithler, Lingolsheim (FR)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: STEELCASE S.A., Schiltigheim (FR)

(21) Appl. No.: 12/593,512

(22) PCT Filed: Mar. 28, 2008
(86) PCT No.: PCT/FR2008/000434

§ 371 Date: Feb. 15, 2010

(30) Foreign Application Priority Data
Mar. 28, 2007 (FR) 07 02237

(51) Int. Cl. H04Q 5/22

(52) U.S. Cl. 340/10.1

(57) ABSTRACT

A system for providing information on pieces of furniture includes a piece of furniture and an electronic device on the piece of furniture. The electronic device contains information and is able to transmit information to an external receiver. The system also includes a locator that covers the electronic device and provides a visible indication of the position of the electronic device.

### BACKGROUND OF THE INVENTION

(1) Field of the Invention

This invention can be applied in the field of furniture, and particularly but not exclusively, of office furniture. It pertains to the marking and identification of pieces of furniture, for commercial as well as utilitarian purposes.

(2) Description of the Related Art

The furniture items feature, to this end, an electronic device, for example of the label type called radio frequency identification, named “Radio Frequency tags” or RFID tags in English. The possibility of identifying, or authenticating goods using radio frequency tags is for example mentioned in the document US 2005/0199723. In this document, there is set out a method for identifying and facilitating the authentication of items including the establishing of a code on the basis of an image, and the association with at least one item to be identified from said image and from a symbol that is readable by a machine.

### SUMMARY OF THE INVENTION

The electronic devices placed on pieces of furniture within the scope of this invention must be able to facilitate a large number of operations potentially occurring in the life of the furniture, from its manufacture to its installation/verification/inventory/end of life with the user, including all of the possible intermediate shipping, delivery operations, etc. Data on these operations can be obtained from a reading of the information contained in a component integrated in a system and which allows, when a suitable reading device is located nearby, the immediate and unequivocal identification of the piece of furniture which is being handled/manipulated.

Given the variety and the number of the operations which can be performed with the aid of this reading and the corresponding number of operators/users, it is eminently important that the latter, over the course of the life of the product, are able to immediately locate the position of the tag or of the identification component on the furniture.

This is the principal goal of this invention.

To this end, the invention pertains more precisely to a system for providing information on pieces of furniture including:
A piece of furniture
An electronic device containing information on said piece of furniture; said electronic device being able to transmit the information to an external receiver;
A locator covering the electronic device and providing a visible indication of the position of said electronic device.

In other words, the furniture which is the subject of the invention features a transmitting device capable of memorizing information which identifies the furniture, and for example, by way of a locator, a marking plate bearing, for example, at least a distinctive sign of the manufacturer, with said marking plate then being fastened to the furniture so as to cover the transmitting device.

The intended goal is to allow users/operators to have the quickest possible access to the device containing the information which identifies the product. It is suitable therefore to position the locator and the electronic device to which it is linked at a place which is visible upon approaching the product, which is moreover the main function of the locator. In the event that it entails a marking plate, the plate then has not only a communication function linked to the (trade)mark, but it also serves as a point of reference for the location of the tag or more generally of the device containing and capable of transmitting information on the product. It must therefore be immediately visible.

Secondarily, the product trademark can then be highlighted, which is not devoid of advantages for the manufacturer. The trademark, or the distinctive signs of the manufacturer, is then in effect always visible. The fact of linking the marking plate with the transmitting device allows moreover the trademark and consequently the manufacturer to be associated, in the consumer's mind, with a reputation of technological innovation which contributes to improving the perception of their image. This association can, moreover, create new opportunities, in terms of use, for the furniture to which a system per the invention is linked. Thus, the number of operations, over the course of the life of the product, that the information contained in the transmitting tags can improve, facilitate, or simply allow, are numerous.

As has been mentioned previously, the electronic device can be a radio frequency identification tag, with this technology being moreover particularly attractive if the device chosen is passive, as it will be explained in more detail hereafter. In this case, the device is a simple label to be adhered to the furniture.

The component integrated in the label can be passive, i.e. transmitting information only when it is subjected to a magnetic field created by an incident radio frequency wave, in the case, for example, of a reader placed a few centimeters from the component.

As mentioned previously, the locator can feature an indication of the origin of the piece of furniture, or a decorative element.

The information contained in the component can be of various kinds. According to one preferential possibility, it can be simply a serial number which, after being read, can be compared to a data base which gives numerous other items of information on the product, its life, its installation, etc. In this case, all of the changes in information concerning the furniture are made in the file which corresponds to it in the data base. It is not at all necessary to make a change in the component on the furniture itself.

When the piece of furniture features an undesirable visible element, the locator can also advantageously be dimensioned and positioned so as to cover the element.

In the event that the office furniture to which the invention pertains is a table, a desk, or more precisely yet, a table or desk top whose peripheral edge is covered with a strip, the undesirable visible element consists of the junction of the ends of the strip. In this case, the locator is place so as to cover said junction.

Thus, the tag equipped with the radio frequency component is likewise adhered at the level of the junction of the ends of the strip. The additional advantage obtained by this placement is of an aesthetic nature: the joint is no longer apparent.

The invention is applicable to all sorts of furniture, and in particular to chairs, space-separating panels, tables, cabinets, white boards, etc. used in various settings such as office furniture, education, health care, etc.

### BRIEF DESCRIPTION OF THE DRAWINGS

FIG. 1 is an exploded view of a work surface, its peripheral edge, the tag or the radio frequency component and the marking plate;

FIG. 2 is a partial perspective view corresponding to that of FIG. 1, with all of the preceding elements being assembled, however;

FIG. 3 shows an operator taking a reading of the information for a piece of furniture of the chair type; and

FIG. 4 represents the same operation for a piece of furniture of the desk type.

### DETAILED DESCRIPTION OF PREFERRED EMBODIMENT

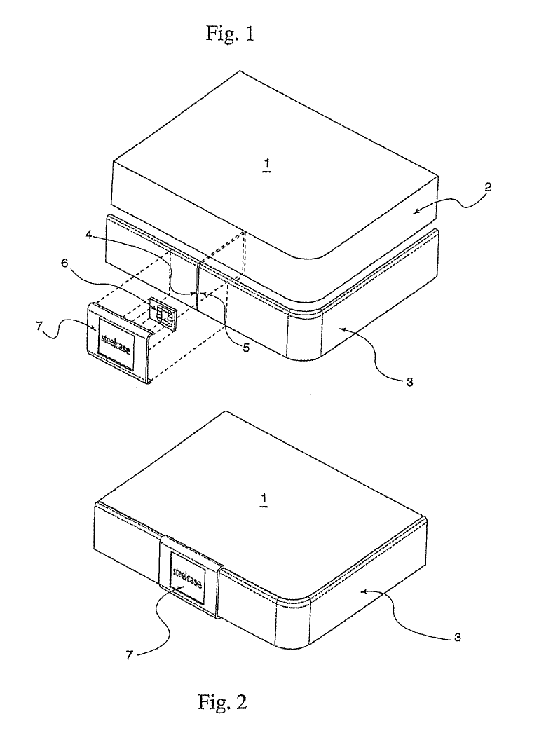

As shown in FIG. 1, the work surface 1 is equipped, on its peripheral edge 2, with a protective strip 3. At the level of the junction of the two ends 4, 5 of said strip 3, a radio frequency identification tag (RFID tag) 6 is adhered. This tag 6 supports an information-memorizing component characterizing the product, and an antenna able to receive the energy of an incident wave transmitted by a reader and to transmit the information in question, upon the approach of this reader.

The entire unit is covered with a marking plate 7 which features a distinctive sign of the manufacturer, for example a trademark and/or a logo.

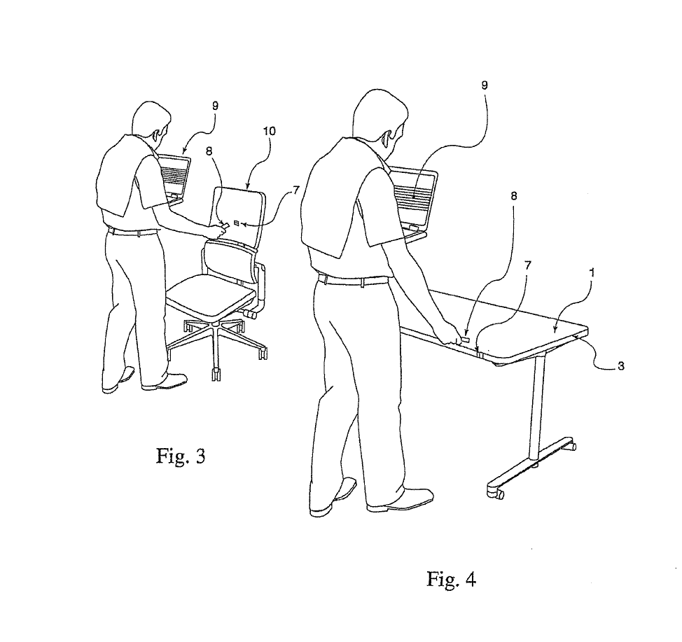

As shown in FIG. 2, all of the elements appearing in FIG. 1 are assembled, and the only elements now visible externally are the strip constituting the edge 3 and the marking plate 7. Once the operator carrying out a so-called identification operation arrives with his reader 8, like the one shown in FIG. 4, he knows immediately where to direct the head of the reader, precisely in the direction of the marking plate 7. The plate, located in this position, is immediately and perfectly visible to the operator when he approaches the desk. The reader can be connected, for example, to a computer 9, of the portable type, which displays the file corresponding to the product on which the reading is performed, a file which can feature variable and modifiable information, such as for example its date of manufacture, its dimensions, its delivery date, where applicable its installation on the premises of its owner, the dates of maintenance operations, etc. Modifications to the nature and quantity of the information are made by changes brought to the program without touching the furniture or the component containing the information allowing its identification.

In FIG. 3, the same operation can be performed on other types of furniture, for example a chair 10. The marking plate 7 is located in the middle of the chair back, and consequently is perfectly visible at first glance by the operator performing the reading.

As has already been mentioned, the component used is preferably a passive component, which features a single code, for example the serial number of the furniture. This serial number suffices to have access to the computer file which gives all of the other information which is necessary or useful for the processing performed by the operator. This configuration allows, as said, a greater flexibility, to the extent that all potential modifications are made to the software.

The use of a label of the RFID tag type allows a simplified and streamlined implementation of the invention, because the component is integrated in a thin piece of paper, which is easily placed behind the marking plate.

It is possible of course to find variations, for example a component arranged on a self-adhesive sticker etc. Due to the contribution of this electronic component, the (trade) mark becomes technological. The ease of managing the equipment, of its inventory is associated with the idea of this trademark. It is furthermore easy to create service solutions which simplify the customers' life.

The potentialities opened up by the identification are numerous, ranging from the birth of the product at the factory, where fitting problems can be solved, up to the end of life, for the possible recycling of the various materials. The invention therefore allows a traceability over the entire life of the product to be put in place. The reading can also be made by the manufacturer as well as by the deliverer, the end customer, or the outside operators charged with recycling the product at end of life.

The transmitting memory device is a passive micro-component equipped with a memory and featuring an antenna which allows the receiving and transmitting of signals originating from and destined for a reader. The advantage of a passive component is that it does not contain an energy source, and there are therefore no maintenance operations to be performed in order to potentially replace such sources. Once the radio wave originating from the reader is captured by the antenna of the label, the magnetic field that is created constitutes the energy source needed for the retransmission of the serial number included in the memory.

The invention is obviously not limited to the example which is given above, but encompasses the variations of location or of structure mentioned. The use of active components, the installation of labels/marking plates elsewhere, etc., are thus also conceivable.

1-15. (canceled)

16. A system for providing information on pieces of furniture, the system comprising:
a piece of furniture;
an electronic device on the piece of furniture, wherein the electronic device contains information, and is capable of transmitting the information to an external receiver;
a locator covering the electronic device and providing a visible indication of the placement of the electronic device.

17. The system of claim 16, wherein:
the electronic device comprises a radio frequency identification label.

18. The system of claim 16, wherein:
the locator includes an indication of the origin of the piece of furniture.

19. The system of claim 16, wherein:
the locator includes a decorative element.

20. The system of claim 16, wherein:
the piece of furniture includes an undesirable visible element;
the locator is dimensioned and positioned so as to cover the undesirable visible element.

21. The system of claim 20, including:
a strip having ends defining a junction; and wherein:
the piece of furniture comprises a desk having a peripheral edge that is covered by the strip;
the undesirable visible element comprises the junction defined by the ends of the strip;
the locator is placed so as to cover the junction.

22. The system of claim 16, wherein:
the information concerning the piece of furniture comprises a serial number of the piece.

23. The system of claim 16, wherein:
the piece of furniture comprises a chair.

24. The system of claim 16, wherein:
the piece of furniture comprises a worksurface.

25. The system of claim 1, wherein:
the piece of furniture is configured for use in an office.

26. An article of furniture, comprising:
a furniture structure;
a radio frequency identification label connected to the furniture structure, wherein the identification label includes a memory feature that stores information related to the furniture structure, and wherein the identification label is capable of transmitting at least some of the information to a portable external receiver; wherein:
the furniture structure includes a external marker directly adjacent the radio frequency identification label such that a portable external receiver can receive the information when the portable external receiver is positioned in the immediate vicinity of the external marker.

27. The article of furniture of claim 26, wherein:
the furniture structure defines an outer surface, and the radio frequency identification label is positioned on the outer surface; and including:
a cover extending over the radio frequency identification label.

28. The article of furniture of claim 27, wherein:
the cover includes visible indicia conveying information concerning the article of furniture.

29. The article of furniture of claim 26, wherein:
the article of furniture comprises a worksurface defining a perimeter, and wherein the radio frequency identification label is mounted on the perimeter.

30. The article of furniture of claim 29, wherein:
the worksurface includes an upwardly-facing planar upper surface, and the perimeter comprises a generally vertical surface; and including:
a generally rectangular cover secured to the perimeter and covering the radio frequency identification label.
